(19) United States
(12) Patent Application Publication
(10) Pub. No.: US 2020/0034555 A1
(43) Pub. Date: Jan. 30, 2020

(54) Image Forming Apparatus and Virus Check Method

(71) Applicant: KONICA MINOLTA, INC., Tokyo (JP)

(72) Inventors: Hiroyuki OHNO, Toyokawa-shi (JP); Takeshi HIBINO, Toyokawa-shi (JP); Hiroaki SUGIMOTO, Nagoya-shi (JP); Takashi SUGAYA, Toyokawa-shi (JP); Taro YAMAMOTO, Toyokawa-shi (JP)

(73) Assignee: KONICA MINOLTA, INC., Tokyo (JP)

(21) Appl. No.: 16/516,889

(22) Filed: Jul. 19, 2019

(30) Foreign Application Priority Data
Jul. 24, 2018 (JP) 2018-138481

(51) Int. Cl. G06F 21/60; H04N 1/00; G06F 21/56; H04L 29/06

(52) U.S. Cl. CPC G06F 21/608; H04N 1/00938; H04N 2201/0094; H04L 63/0414; H04L 63/1416; G06F 21/566

(57) ABSTRACT

An image forming apparatus includes a virus check unit that performs a virus check, a reception unit that receives data from an external apparatus, and an execution control unit that causes the virus check unit to perform the virus check on the data when a specific condition is satisfied after the receipt of the data.

The entire disclosure of Japanese Patent Application No. 2018-138481, filed on Jul. 24, 2018, is incorporated herein by reference in its entirety.

### BACKGROUND

### Technological Field

The present invention relates to an image forming apparatus and a virus check method performed by an image forming apparatus.

### Description of the Related Art

An image forming apparatus, which is a copying machine, a printer, a facsimile, or a multi-functional peripheral of these, has been conventionally known. Such an image forming apparatus is connected with any other apparatus over a network. Thus, an image forming apparatus that performs a virus check on received data has been developed.

For example, Japanese Laid-Open Patent Publication No. 2006-256104 discloses the following configuration as an apparatus (specifically, a printer) that performs a virus check. In this configuration, “when data received from a client PC is held in a memory, if virus contamination of the held data is detected by a control program executed by a main CPU, a panel is notified of the virus contamination, and secondary infection by the virus contained in the data stored in the memory is prevented” (see Abstract). Specifically, the apparatus of Japanese Laid-Open Patent Publication No. 2006-256104 interrupts a power supply if the received data contains a virus.

### SUMMARY

The apparatus of Japanese Laid-Open Patent Publication No. 2006-256104 starts a virus check upon receipt of data. This may cause a conflict between the virus check and processing of any other job. In such a case the processing of the other job delays, reducing the productivity of the apparatus.

The present disclosure has been made in view of the above problem and has an object to provide an image forming apparatus capable of suppressing a reduction in productivity due to a virus check.

To achieve at least one of the abovementioned objects, according to an aspect of the present invention, an image forming apparatus reflecting one aspect of the present invention comprises virus check means for performing a virus check, receiving means for receiving data from an external apparatus, and execution control means for causing the virus check means to perform the virus check on the data when a specific condition is satisfied after the receipt of the data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 shows a schematic configuration of an image forming system according to an embodiment of the present invention.

FIG. 2 schematically shows an internal structure of an image forming apparatus.

FIG. 3 is a block diagram showing an example hardware configuration of a main body.

FIG. 4 is a functional block diagram for illustrating a functional configuration of the image forming apparatus.

FIG. 5 is a flowchart for illustrating a flow of processes performed by the image forming apparatus.

FIG. 6 is a functional block diagram for illustrating a first specific example of the functional configuration of the image forming apparatus.

FIG. 7 is a flowchart showing a specific example of step S3.

FIG. 8 is a flowchart showing a specific example of step S4.

FIG. 9 is a functional block diagram for illustrating a second specific example of the functional configuration of the image forming apparatus.

FIG. 10 is a flowchart showing a specific example of step S3.

FIG. 11 is a functional block diagram for illustrating a third specific example of the functional configuration of the image forming apparatus.

FIG. 12 is a flowchart showing a specific example of step S3.

FIG. 13 is a flowchart showing a specific example of step S4.

FIG. 14 is a flowchart showing a modification of step S3.

FIG. 15 is a functional block diagram for illustrating a fourth specific example of the functional configuration of the image forming apparatus.

FIG. 16 is a flowchart showing a specific example of step S3.

FIG. 17 is a functional block diagram for illustrating a fifth specific example of the functional configuration of the image forming apparatus.

FIG. 18 is a flowchart showing a specific example of step S3.

FIG. 19 is a functional block diagram for illustrating a sixth specific example of the functional configuration of the image forming apparatus.

FIG. 20 is a flowchart showing a specific example of step S3.

FIG. 21 is a functional block diagram for illustrating a seventh specific example of the functional configuration of the image forming apparatus.

FIG. 22 is a flowchart showing a specific example of step S3.

### DETAILED DESCRIPTION OF EMBODIMENTS

Hereinafter, one or more embodiments of the present invention will be described with reference to the drawings. However, the scope of the invention is not limited to the disclosed embodiments.

An image forming apparatus in an embodiment will be described below with reference to the accompanying drawings. In the embodiment described below, when the number, the quantity, and the like are mentioned, the scope of the present invention is not necessarily limited thereto unless otherwise specified. The same or corresponding components are designated by the same reference characters, and description thereof may not be repeated.

In the accompanying drawings, illustrations are not based on the actual dimensional ratio, and there are some parts shown in different dimensional ratios for clearly illustrating the structure in order to allow easy understanding of the structure. Embodiments and modifications described below may be selectively combined as appropriate.

Although an image forming apparatus serving as a color printer will be described below, the image forming apparatus is not limited to a color printer. For example, the image forming apparatus may be a monochrome printer, a facsimile (FAX), or a multi-functional peripheral (MPF) including a monochrome printer, a color printer, and a FAX.

### A. System Configuration

### a1: Image Forming System 1

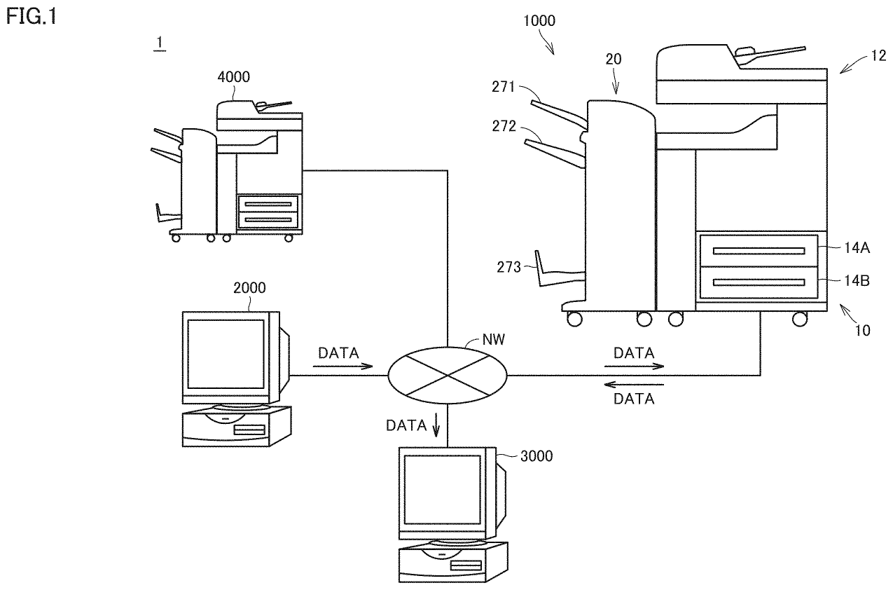

FIG. 1 shows a schematic configuration of an image forming system 1 according to the present embodiment.

Referring to FIG. 1, image forming system 1 includes image forming apparatuses 1000 and 4000, and client personal computers (PCs) 2000 and 3000, which are example image processors. Client PCs 2000 and 3000 and image forming apparatus 4000 are communicatively connected with image forming apparatus 1000 through a network controller (not shown).

Image forming apparatus 1000 includes a main body 10, a postprocessor 20, and an operation panel (not shown).

Main body 10 includes a scanner unit 12 and paper feed trays 14A and 14B. Main body 10 includes a multifunction peripheral/product/printer (MFP) having a scanner function, a copy function, a printer function, a FAX function, a data communication function, and a server function. Main body 10 can execute a copy job, a print job, a scan job, a FAX job, and a box job.

Postprocessor 20 includes a plurality of paper ejection trays 271, 272, and 273. A user can instruct, for example, image forming apparatus 1000 to perform printing from client PC 2000. The user can also cause scanner unit 12 to scan a document to perform printing in image forming apparatus 1000.

Client PCs 2000 and 3000 store a printer driver for PC printing and a PC-resident application for assisting a printer driver operation.

Image forming apparatus 4000 has a configuration similar to that of image forming apparatus 1000. Description of a specific configuration of image forming apparatus 4000 will thus not be repeated. Description will be given below focusing on image forming apparatus 1000 of image forming apparatuses 1000 and 4000. Also, description will be given of an example ease in which client PC 2000 of client PCs 2000 and 3000 transmits data to image forming apparatus 1000. Client PC 2000 corresponds to the external apparatus to image forming apparatus 1000.

### a2: Internal Structure of Image Forming Apparatus 1000

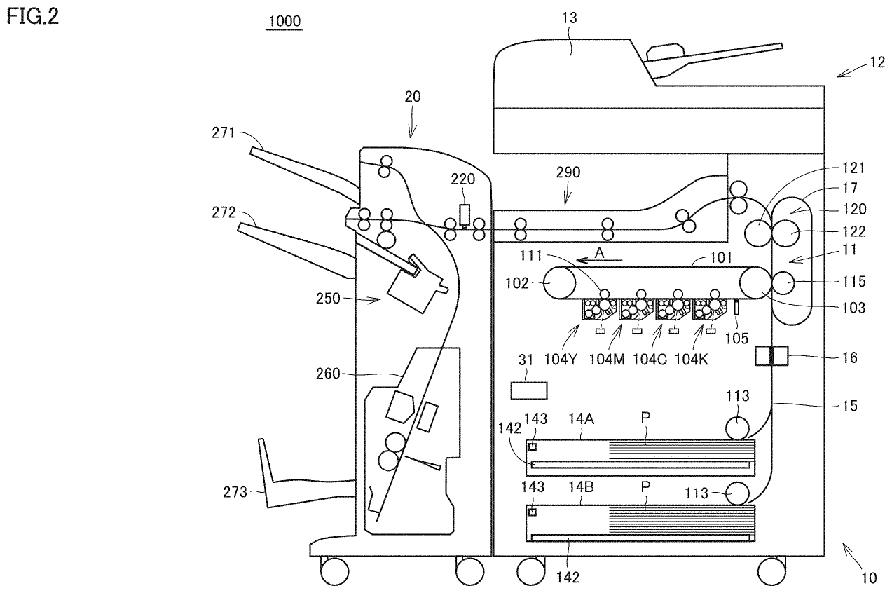

FIG. 2 schematically shows an internal structure of image forming apparatus 1000. Referring to FIG. 2, image forming apparatus 1000 includes main body 10 and postprocessor 20 as described above.

Main body 10 includes an image forming unit 11, scanner unit 12, an automatic original transport unit 13, paper feed trays 14A and 14B, a transport path 15, a media sensor 16, a reverse transport path 17, and paper feed rollers 113.

Main body 10 further includes a controller 31 (processor), which controls an operation of image forming apparatus 1000. In the present embodiment, main body 10 is a so-called tandem color printer. Main body 10 performs image formation based on print settings.

Automatic original transport unit 13 automatically transports an original placed on a platen to a scanning position of an original scanning unit. Scanner unit 12 scans an image of the original transported by automatic original transport unit 13 and generates scanned data.

Paper feed trays 14 A and 14B accommodate sheets of paper P. Paper feed roller 113 sends sheets or paper P upward along transport path 15.

Transport path 15 is used in single-sided printing and double-sided printing. Reverse transport path 17 is used in double-sided printing.

Image forming unit 11 performs image formation on sheets of paper P supplied from paper feed trays 14A and 14B based on the scanned data generated by seamier unit 12 or printing data obtained from client PC 2000.

Image forming unit 11 includes an intermediate transfer belt 101, resist rollers 102 and 103, a yellow image forming portion 104Y, a magenta image forming portion 104M. a cyan image forming portion 104C, a black image forming portion 104K, an image density sensor 105, a primary transfer device 111, a secondary transfer device 115, and a fixing device 120.

Media sensor 16 is provided on transport path 15. Media sensor 16 implements a paper type automatic detection function.

Postprocessor 20 further includes a punching device 220, a side stitching portion 250. a saddle stitching portion 260, paper ejection tray 271, paper ejection tray 272, and paper ejection tray 273 which is located in the lower portion thereof.

### a3. Hardware Configuration of Main Body 10

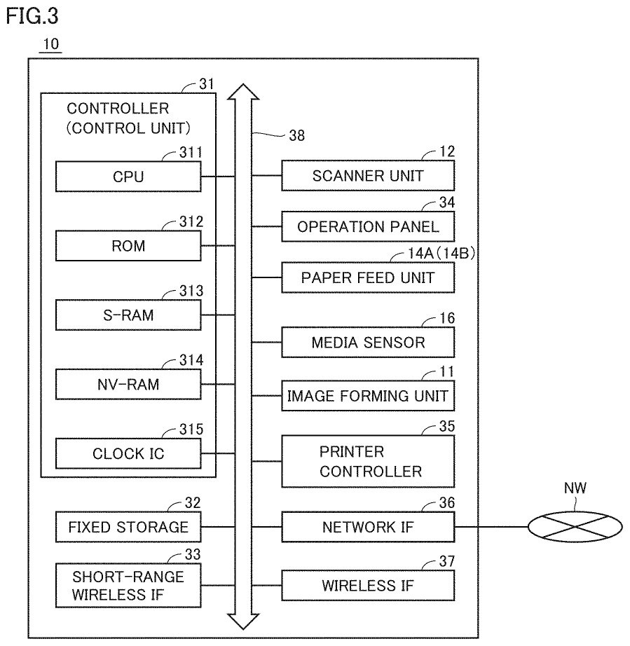

FIG. 3 is a block diagram showing an example hardware configuration of main body 10.

Referring to FIG. 3, main body 10 includes controller 31, a fixed storage 32, a short-range wireless interface (IF) 33, scanner unit 12, an operation panel 34, paper feed trays 14A and 14B, media sensor 16, image forming unit 11, a printer controller 35, a network IF 36, and a wireless IF 37. Controller 31 is connected with the components 11, 12, 14A, 14B, 16, and 32 to 37 through a bus 38.

Controller 31 includes a central processing unit (CPU) 311, a read only memory (ROM) 312 storing a control program, a static random access memory (S-RAM) 313 for work, a battery-backed-up non-volatile RAM (NV-RAM: nonvolatile memory) 314 for storing various settings regarding image formation, and a clock integrated circuit (IC) 315. The components 311 to 315 are connected through bus 38.

Operation panel 34 includes keys for various inputs and a display. Operation panel 34 is typically composed of a touch screen and a hardware key. The touch screen is a device in which a touch panel is placed on a display.

Network IF 36 transmits and receives various types of information to and from external apparatuses such as client PCs 2000 and 3000 and image forming apparatus 4000 connected through a network 39.

Printer controller 35 generates a copy image from print data received through network IF 36. Image forming unit 11 forms a copy image on the sheet of paper.

Fixed storage 32 is typically a hard disk device. Fixed storage 32 stores various types of data.

### B. Overview of Process

### b1. Technical Idea

The image forming apparatus having a virus check originally docs not need to perform a virus check immediately after receiving data as described below.

Specifically, though the image forming apparatus performs a printing process, a display process, a storing process, a transmission process, and any other process on the received data, the image forming apparatus itself is at a low risk of virus infection in any of the processes. The reason for this will be described below.

### (1) Printing Process and Display Process

A process of scanning the data (file) contents occurs. However, since the image forming apparatus deals with the data as image format data, the imaging forming apparatus docs not access any uniform resource locator (URL) or file path leading to a malicious website which may be described on this data. This leads to a low risk of virus infection.

### (2) Storing Process

The image forming apparatus merely stores the data (file) in a save area of the image forming apparatus and docs not open the data. This leads to a low risk of virus infection.

### (3) Transmission Process

Since the image forming apparatus docs not open data (file), it is at a low risk of virus infection. Also, if data other than image data is transmitted to the image forming apparatus by a malicious person, a risk of virus infection is low as described below.

Even when a URL or file path of a malicious website is described on data and the data is a file that will infect the PC when the data is about to be opened on the PC, the image forming apparatus still deals with this data as image data. Thus, a situation in which “the image forming apparatus reads the URL and accesses a link destination in the course of the image process” will not occur. It is accordingly conceivable that the image forming apparatus itself will be at a low risk of virus infection and a virus check will not be necessary.

As described above, however, damage due to secondary infection, in which “the image forming apparatus transmits data to any other apparatus, and accordingly, the other apparatus is infected with a virus,” should be prevented. Thus, it suffices that the image forming apparatus performs a virus check between reception of data and redistribution of the data to outside. From this point of view, image forming apparatus 1000 according to the present embodiment performs a virus check between reception of data and redistribution of the data to outside.

### 2. Image Forming Apparatus 1000

An overview of the processes of image forming apparatus 1000 will be described.

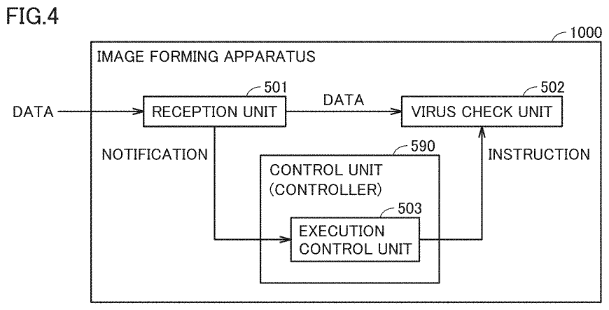

FIG. 4 is a functional block diagram for illustrating a functional configuration of image forming apparatus 1000.

Referring to FIG. 4, image forming apparatus 1000 includes a reception unit (receiving means, receiver) 501, a virus check unit (virus check means, virus checker) 502, and a control unit 590. Control unit 590 includes an execution control unit (execution control means, controller) 503.

Control unit 590 controls a general operation of image forming apparatus 1000. Control unit 590 corresponds to controller 31 (see FIG. 3). Specifically, control unit 590 is implemented as CPU 311 of controller 31 executes the program stored in a memory (such as ROM 312 or S-RAM 313) of controller 31.

Reception unit 501 receives data from the external apparatus. In this example, reception unit 501 receives data from client PC 2000.

Virus check unit 502 performs a virus check on the data received by reception unit 501. Specifically, virus check unit 502 checks whether the data contains a virus.

When determining that the data contains a virus, virus check unit 502 provides a predetermined notification to control unit 590. In this case, control unit 590 performs a predetermined process. For example, control unit 590 performs a predetermined display on operation panel 34 or provides a predetermined notification to a data source.

Execution control unit 503 controls the operation of virus check unit 502. Specifically, execution control unit 503 causes virus check unit 502 to perform a virus check. More specifically, when a specific condition is satisfied after the receipt of the data by reception unit 501, execution control unit 503 causes virus check unit 502 to perform a virus check on the data.

More specifically, execution control unit 503 determines whether the specific condition is satisfied after the receipt of the data by reception unit 501. Based on the determination that the specific condition is satisfied, execution control unit 503 anises virus check unit 502 to perform a virus check on the data. A specific example of the “specific condition” will be described below.

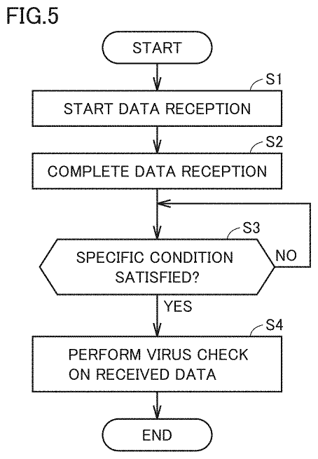

FIG. 5 is a flowchart for illustrating a flow of the processes performed by image forming apparatus 1000. At step S1, image forming apparatus 1000 starts receiving data transmitted from client PC 2000 which is an external apparatus.

Upon completion of the data reception (step S2), at step S3, image forming apparatus 1000 determines whether a specific condition is satisfied. When determining that the specific condition is satisfied (YES at step S3), at step S4, image forming apparatus 1000 performs a virus check on the received data (data whose reception is complete at step S2). When determining that the specific condition is not satisfied (NO at step S3), image forming apparatus 1000 returns the process to step S3.

In this manner, image forming apparatus 1000 docs not perform a virus check upon externally receiving data and performs a virus check when the specific condition is satisfied after the receipt of the data.

Such a configuration can less affect the productivity of image forming apparatus 1000 than a conventional virus check method (a method of starting a virus check upon receipt of data) while preventing damage due to secondary infection from image forming apparatus 1000 to any other apparatus.

### C. Specific Example

Specific examples (a first specific example to a seventh specific example) of the processes of image forming apparatus 1000 described above will now be described. Specifically, a specific example of step S3 (i.e., a specific example of the “specific condition”) and a specific example of step S4 of FIG. 5 will be described.

### c1. First Specific Example (Process Example based on CPU Load)

For example, in a situation in which image forming apparatus 1000 has no job being executed and no internal process such as image stabilization, the CPU load of image forming apparatus 1000 is conceivably low. It can be said that in such a situation, a load on image forming apparatus 1000 is low even when a virus check is performed and any other process is affected little. In this example, thus, when a CPU load of image forming apparatus 1000 is less than a threshold, it is determined that the “specific condition” is satisfied, and a virus check is performed.

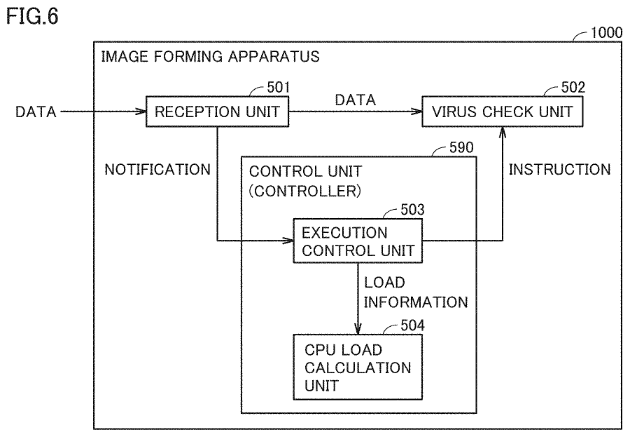

FIG. 6 is a functional block diagram for illustrating a first specific example of the functional configuration of image forming apparatus 1000.

Referring to FIG. 6, image forming apparatus 1000 includes reception unit 501, virus check unit 502, and control unit 590. Control unit 590 includes execution control unit 503 and a CPU load calculation unit 504. Image forming apparatus 1000 in this example differs from the configuration shown in FIG. 4 in that it includes CPU load calculation unit 504.

CPU load calculation unit 504 calculates a load of CPU 311 (see FIG. 3). Specifically, CPU load calculation unit 504 periodically calculates a load factor (activity ratio) of CPU 311. CPU load calculation unit 504 notifies execution control unit 503 of the calculated load.

When the load of CPU 311 is less than a threshold, execution control unit 503 determines that the “specific condition” is satisfied, and causes virus check unit 502 to perform a virus check on the received data. When the load of CPU 311 reaches the threshold or more during the virus check, execution control unit 503 causes virus check unit 502 to interrupt the virus check. When the load of CPU 311 falls below the threshold after the interruption of the virus check, execution control unit 503 causes virus check unit 502 to restart the virus check.

As described above, execution control unit 503 determines whether to cause virus check unit 502 to perform a virus check on the received data in accordance with the load of CPU 311.

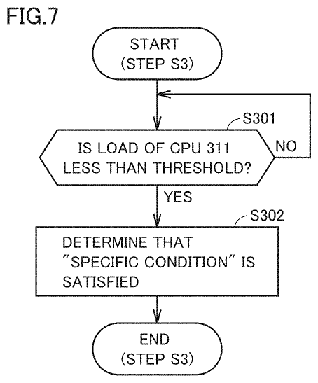

FIG. 7 is a flowchart showing a specific example of step S3.

Referring to FIG. 7, at step S301, control unit 590 (controller 31) of image forming apparatus 1000 determines whether the load of CPU 311 is less than a threshold. When determining that the load is less than the threshold (YES at step S301), at step S302. control unit 590 determines that a “specific condition” is satisfied. When determining that the load is equal to or more than the threshold (NO at step S301), control unit 590 returns the process to step S301.

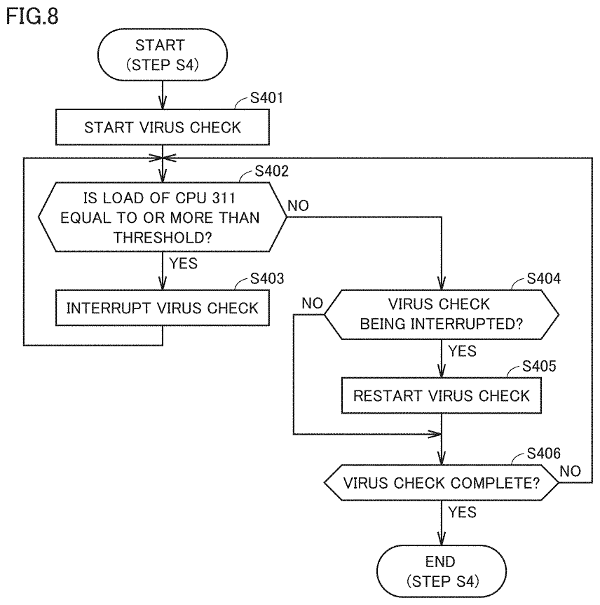

FIG. 8 is a flowchart showing a specific example of step S4.

Referring to FIG. 8, at step S401, virus check unit 502 of image forming apparatus 1000 starts a virus check based on an instruction from execution control unit 503. At step S402, execution control unit 503 determines whether the load of CPU 311 reaches the threshold or more based on the load information.

When determining that the load is equal to or more than the threshold (YES at step S402), at step S403, execution control unit 503 controls virus check unit 502 to interrupt the virus check.

When determining that the load is less than the threshold (NO at step S402), at step S404, execution control unit 503 determines whether the virus check is being interrupted. For example, execution control unit 503 can determine as described above if it has a flag indicating whether the virus check is being interrupted.

When determining that the virus check is being interrupted (YES at step S404), at step S405, execution control unit 503 controls virus check unit 502 to restart the virus check.

When determining that the virus check is being performed (NO at step S404), at step S406, execution control unit 503 determines whether the virus check is complete. For example, as execution control unit 503 is configured to accept a notification of virus check completion from virus check unit 502 after the completion of the virus check, execution control unit 503 can determine whether the virus check is complete.

When determining that the virus check is not complete (NO at step S406), control unit 590 advances the process to step S401. When determining that the virus check is complete (YES at step S406), control unit 590 ends the process of step S4.

### Advantages of First Specific Example

A conventional virus check method causes, for example, a problem as described below.

When a user transmits a document file to an image forming apparatus during copying by another user using the image forming apparatus, the image forming apparatus starts a virus check on the received document file simultaneously with a copy job. Particularly depending on office environment, a timing at which the image forming apparatus receives data in a concentrated manner may occur; for example, users send necessary documents from their own PCs to the image forming apparatus and print the documents at a timing before a meeting. In addition to the ease in which multiple people send documents simultaneously, one person may conceivably send materials for all the meeting attendees to the image forming apparatus and copy the materials at once.

If a virus check is performed every time data is received in such a situation, multiple virus checks operate simultaneously. When another user tries to perform an operation such as copying in front of the image forming apparatus in this situation, the load of the image forming apparatus becomes higher, and accordingly, the other user may have to wait longer than normal until the completion of the copy job.

However, a reduction in the productivity of image forming apparatus 1000 can be reduced by avoiding a virus check when the CPU load is high as in image forming apparatus 1000 of this example.

### Priority of Virus Check

From which data a virus check is performed sequentially when a plurality of pieces of received data are present in a memory (specifically, a data save area of the memory) of image forming apparatus 1000 will be described using a plurality of examples.

(1) For example, conceivably, when old data stored one week ago and new data stored several minutes ago are present in the data save area of image forming apparatus 1000, the old data is more likely to be forgotten while being stored, and the data stored more recently is more likely to be used first.

When performing a virus check as the load of CPU 311 falls below the threshold, thus, virus check unit 502 sorts pieces of data held therein in the order of a date and time of storage, and performs a virus check in favor of a piece of data with a more recent date and time of storage.

(2) Control unit 590 can determine that a virus check has been performed on data (typically, file) which has been subjected to a virus check once. Specifically, the information indicating that a virus check has been performed is written into the header of the data, or a dedicated management file is prepared separately, thus allowing control unit 590 to determine on which data a virus check has been performed.

When performing a virus check as the load of CPU 311 falls below the threshold, virus check unit 502 refers to header information (or management file) and performs a virus check in favor of a piece of data whose virus check is not complete.

(3) A period of time required for a virus check depends on a data size. As the data size is larger, a more period of time is required for a virus check. Thus, for example, in a situation in which a plurality of pieces of data having different data sizes are present in image forming apparatus 1000, when a virus check is performed starting from a piece of data with a larger data size, a longer period of time is required for the virus check of this data, leading to a delayed delay of a virus check on another piece of data.

Contrastingly, more pieces of data can be checked early by starting a virus check from a piece of data having a smaller data size.

Considering the above, when performing a virus check as the load of CPU 311 falls below a threshold, virus check unit 502 sorts pieces of data held therein in the order of data size, and performs a virus check in favor of a piece of data with a smaller data size.

### Modification of First Specific Example

In the above ease, since a “specific condition” is not satisfied when the load of CPU 311 is equal to or more than a threshold, execution control unit 503 does not cause virus check unit 502 to perform a virus check.

By preliminarily specifying a process with a high load of CPU 311, execution control unit 503 can determine whether to cause virus check unit 502 to perform a virus check without determining the load of a CPU. Examples of the process with a high load include image formation, scanning, and image stabilization.

During the process (image formation, scanning, or image stabilization) by image forming apparatus 1000, execution control unit 503 may determine that a specific condition is not satisfied, as described above.

### c2: Second Specific Example (Process Example Based on Transmission Reservation)

Image forming apparatus 1000 has a function of allowing a user to preliminarily designate a dale and time at which data is to be transmitted. When a transmission reservation is made using this function, it can be said that transmission of data externally to image forming apparatus 1000 is clear in advance. In this example, thus, at a point of time when the setting of a transmission time is accepted (at a point of time when a transmission reservation is made), it is determined that a “specific condition” is satisfied, and then, a virus check is performed on data to be transmitted.

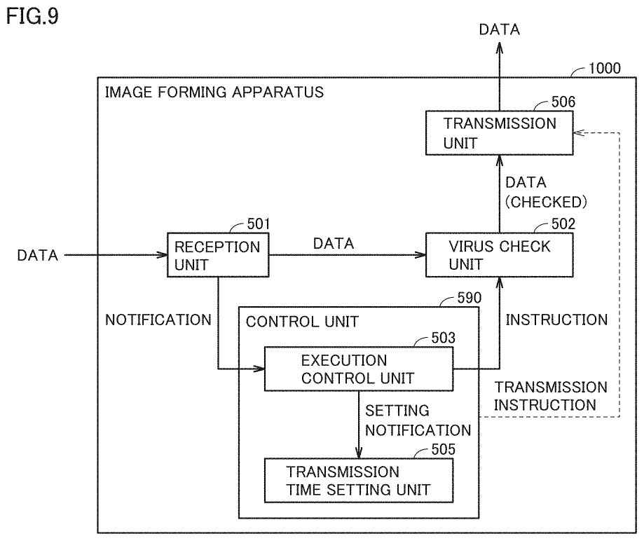

FIG. 9 is a functional block diagram for illustrating a second specific example of the functional configuration of image forming apparatus 1000.

Referring to FIG. 9, image forming apparatus 1000 includes reception unit 501, virus check unit 502, control unit 590, and a transmission unit (transmitter, transmission means) 506. Control unit 590 includes execution control unit 503 and a transmission time setting unit 505. Image forming apparatus 1000 of this example differs from the configuration shown in FIG. 4 in that it includes transmission time setting unit 505 and transmission unit 506.

Transmission unit 506 transmits data to a designated destination through a network NW (see FIG. 1). The timing of data transmission by transmission unit 506 is controlled by control unit 590.

Transmission time setting unit 505 sets a time of data transmission based on a user's instruction. Transmission time setting unit 505 notifies execution control unit 503 that the setting has been made.

Execution control unit 503 is triggered by the setting made after the receipt of data to cause virus check unit 502 to start a virus check on the data.

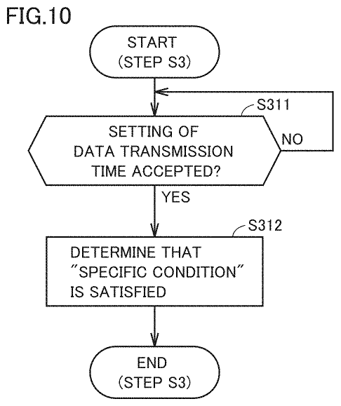

FIG. 10 is a flowchart showing a specific example of step S3.

Referring to FIG. 10, at step S311, control unit 590 (controller 31) of image forming apparatus 1000 determines whether it has accepted the setting of a date and time of data transmission. When determining that it has accepted the setting (YES at step S311), at step S312, control unit 590 determines that a “specific condition” is satisfied. When determining dial it has not accepted the setting (NO at step S311), control unit 590 returns the process to step S311.

### c3. Third Specific Example (Process Example Based on External Transmission)

Image forming apparatus 1000 may transmit data to an external apparatus (in this example, client PC 3000). For example, image forming apparatus 1000 may send e-mail to client PC 3000 (push transmission from image forming apparatus 1000) through a network NW by accepting an operation to operation panel 34. Also, client PC 3000 may access the storage (typically, hard disk drive (HDD)) of image forming apparatus 1000 by using a server message block (SMB) protocol to obtain data (perform pull transmission from image forming apparatus 1000).

In this example, thus, in data transmission from image forming apparatus 1000 to an external communication apparatus through network NW, image forming apparatus 1000 determines that a “specific condition” is satisfied, and performs a virus check on data that is a transmission target among pieces of data received from the external apparatus (in this example, client PC 2000).

Also in data transmission (output) to an external storage medium such as a USB memory 5000 or an external HDD (not shown), which is physically connected to image forming apparatus 1000 without a network, there is a risk of secondary infection to any other apparatus through the external storage medium. In this example, thus, also when data within image forming apparatus 1000 is moved or copied to an external storage medium (when data is transmitted), image forming apparatus determines that a “specific condition” is satisfied, and performs a virus check on the data.

These aspects will be described specifically below.

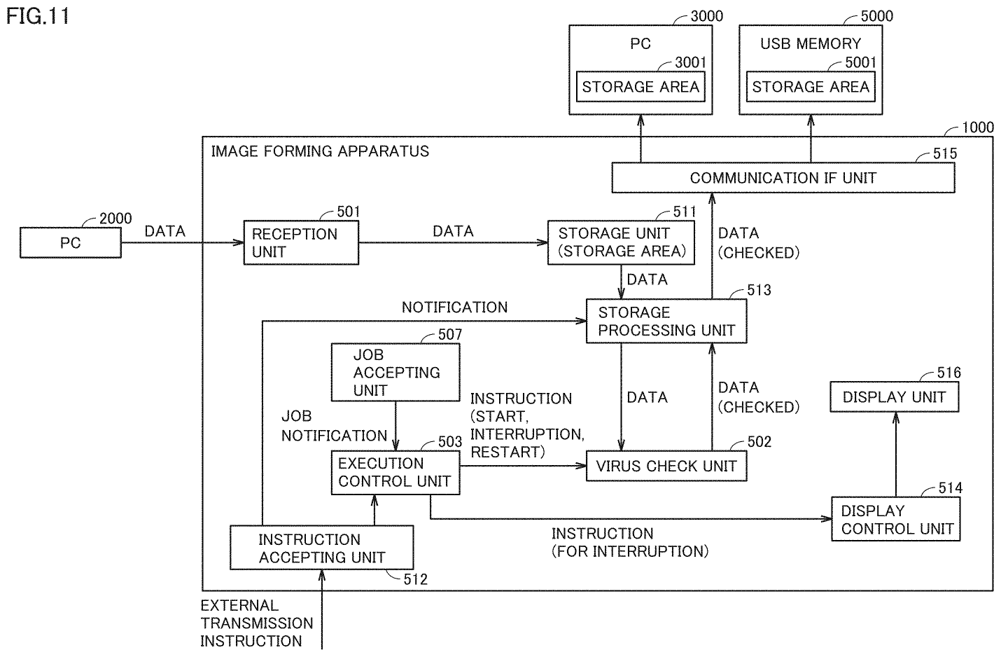

FIG. 11 is a functional block diagram for illustrating a third specific example of the functional configuration of image forming apparatus 1000.

Referring to FIG. 11, image forming apparatus 1000 includes reception unit 501. virus check unit 502, execution control unit 503, a job accepting unit 507, a storage unit 511 (memory, storage means), an instruction accepting unit 512, a storage processing unit 513, a display control unit 514, a communication IF unit 515, and a display unit (display) 516. Execution control unit 503, job accepting unit 507, storage processing unit 513, and display control unit 514 are included in control unit 590. Display unit 516 corresponds to operation panel 34.

The data received from client PC 2000 by reception unit 501 is stored in storage unit 511.

Instruction accepting unit 512 accepts various instructions from a user. Instruction accepting unit 512 accepts an instruction through operation panel 34. Alternatively, instruction accepting unit 512 externally accepts an instruction through network NW.

For example, instruction accepting unit 512 accepts an instruction to externally transmit data stored in storage unit 511 (hereinbelow, also referred to as “transmission instruction”). The transmission instruction includes information for identifying a destination. In this example, examples of the destination include client PC 3000 and a universal serial bus (USB) memory 5000. USB memory 5000 is directly inserted into a USB port of image forming apparatus 1000 without network NW. Data transmission includes data movement, in which no data is left in a source, and data replication, in which data is left also in a source.

Upon receipt of a transmission instruction, instruction accepting unit 512 transmits a predetermined notification to execution control unit 503 and storage processing unit 513.

Upon receipt of the notification from instruction accepting unit 512, storage processing unit 513 reads data from storage unit 511. Execution control unit 503 instructs virus check unit 502 to perform a virus check on the data read from storage processing unit 513 by storage unit 511.

Virus check unit 502 transmits data whose virus check is complete to storage processing unit 513. Storage processing unit 513 transmits the data whose virus check is complete to a designated destination (client PC 2000, USB memory 5000, or HDD (not shown)) through communication IF unit 515.

In this manner, image forming apparatus 1000 includes at least storage unit 511 that stores the data received by reception unit 501, instruction accepting unit 512 that accepts an external transmission instruction, and storage processing unit 513 that causes, in response to the acceptance of the external transmission instruction by instruction accepting unit 512, a storage area (a storage area 3001 of client PC 3000, a storage area 5001 of USB memory 5000, or a storage area of the HDD (not shown)) to store the data stored in storage unit 511.

Execution control unit 503 is triggered by the acceptance of an external transmission instruction by instruction accepting unit 512 to cause virus check unit 502 to start a virus check on the data stored in storage unit 511 before storing this data in the external storage area (storage area 3001, storage area 5001, or the storage area of the HDD (not shown)).

For example, when storage processing unit 513 stores data in storage area 3001 of client PC 3000 (i.e., transmits data to client PC 3000), execution control unit 503 causes virus check unit 502 to perform a virus check on the data before storage processing unit 513 transmits this data.

As described above, image forming apparatus 1000 docs not perform a virus check upon externally receiving data, and is triggered by the acceptance of an external transmission instruction by instruction accepting unit 512 after the receipt of the data, thereby performing a virus check. Such a configuration can less affect the productivity of image forming apparatus 1000 than a conventional virus check method (a method of starting a virus check upon receipt of data) while preventing damage due to secondary infection from image forming apparatus 1000 to any other apparatus.

A process of interrupting and restarting a virus check will be described below.

When image forming apparatus 1000 accepts an operation of externally transmitting received data by email through operation panel 34, image forming apparatus 1000 performs a virus check before transmission of the data as described above. When another user different from the user who has performed the transmission operation performs a new operation (e.g., client PC 3000 transmits data to the save area of image forming apparatus 1000) during the virus check, image forming apparatus 1000 interrupts the virus check. This can eliminate an influence of performance on the process performed by the other user.

Although image forming apparatus 1000 has not completed data transmission because the virus check is being interrupted in actuality, image forming apparatus 1000 displays on operation panel 34 an indication that the transmission is complete. This can complete the operation of the user trying to perform data transmission. Thus, this can also eliminate a situation in which the user is kept waiting in front of image forming apparatus 1000. In this case, upon completion of the operation of another user, image forming apparatus 1000 restarts the virus check and performs data transmission after the completion of the virus check.

The process of interrupting and restarting a virus check will be specifically described as follows.

Job accepting unit 507 accepts a job. For example, job accepting unit 507 accepts a job through instruction accepting unit 512, or accepts jobs from client PCs 2000 and 3000.

When job accepting unit 507 accepts a new job during the virus check, the following process is performed.

Job accepting unit 507 notifies execution control unit 503 of the acceptance of the new job. Execution control unit 503 instructs virus check unit 502 to interrupt the execution of the virus check. Consequently, virus check unit 502 interrupts the virus check.

Further, when receiving this notification from job accepting unit 507, execution control unit 503 sends a predetermined instruction to display control unit 514. When receiving this notification, display control unit 514 causes display unit 516 to display the completion of data transmission.

As described above, execution control unit 503 performs control of interrupting a virus check when a new job occurs during the virus check. In response to the interruption of the virus check, display control unit 514 causes display unit 516 to display the completion of data transmission. When the job ends, execution control unit 503 causes virus check unit 502 to restart the virus check that has been interrupted. Such a configuration can less affect the productivity of image forming apparatus 1000.

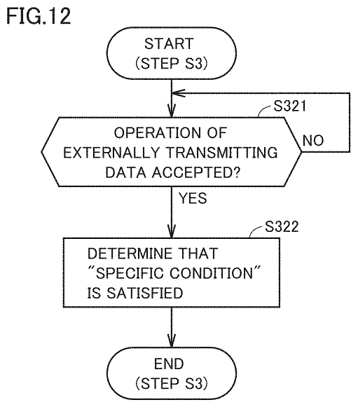

FIG. 12 is a flowchart showing a specific example of step S3.

Referring to FIG. 12, at step S321, control unit 590 (controller 31) of image forming apparatus 1000 determines whether it has accepted the operation of externally transmitting data. When determining that it has accepted the operation (YES at step S321), at step S322, control unit 590 determines that a “specific condition” is satisfied. When determining that it has not accepted the operation (NO at step S321), control unit 590 returns the process to step S321.

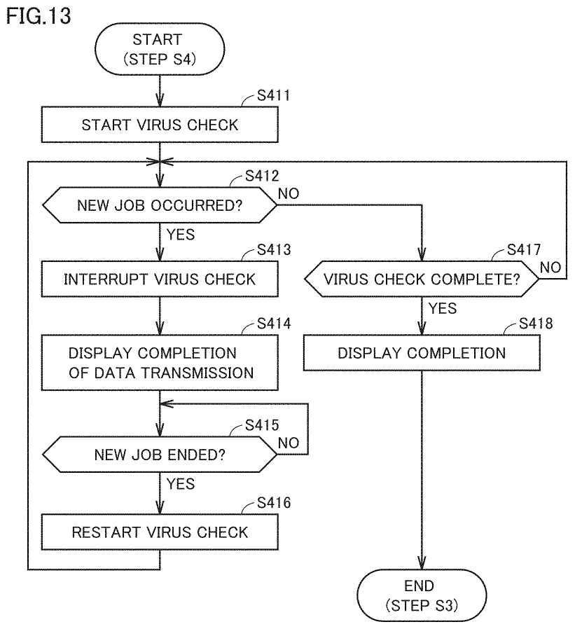

FIG. 13 is a flowchart showing a specific example of step S4.

Referring to FIG. 13, at step S411, virus check unit 502 of image forming apparatus 1000 starts a virus check based on an instruction from execution control unit 503. At step S412, control unit 590 determines whether a new job has occurred.

When determining dial a new job has occurred (YES at step S412), at step S413, virus check unit 502 interrupts the virus check based on the instruction from execution control unit 503. When determining that a new job has not occurred (NO at step S412), control unit 590 advances the process to step S417.

At step S414, display control unit 514 causes display unit 516 to display the completion of the data transmission. At step S413, control unit 590 determines whether the new job has ended. Control unit 590 performs this determination by, for example, receiving a job end notification from job accepting unit 507.

When it is determined that the new job has ended (YES at step S415), at step S416. virus check unit 502 restarts the virus check based on an instruction from execution control unit 503. After that, the process proceeds to step S412. When it is determined that the new job has not been ended (NO at step S415), virus check unit 502 waits until the job is ended.

At step S417, execution control unit 503 determines whether the virus cheek is complete at step S417 based on the notification from virus check unit 302. When it is determined that the virus check is complete (YES at step S417), at step S418, display control unit 514 causes display unit 516 to display the completion. When it is determined that the virus check is not complete, control unit 590 advances the process to step S412.

### Modification of Third Specific Example

A modification of the third specific example will be described below. Specifically, a modification example of the process flow shown in FIG. 12 will be described.

### (1) First Modification (Process of Data Transmission to Another Other Image Forming Apparatus)

For example, in the use of a function (such as ubiquitous print) of transmitting document data from image forming apparatus 1000 to another image forming apparatus (e.g., image forming apparatus 4000 shown in FIG. 1), a data destination is the image forming apparatus. As described above, a risk of virus infection of the image forming apparatus itself is conceivably low. It is thus conceivable that when a destination is the image forming apparatus, no problem will arise if image forming apparatus 1000 that is a data source docs not perform a virus check.

In this modification, thus, when a destination is the image forming apparatus, it is not determined that a “specific condition” is satisfied, and data is transmitted without performing a virus check. Contrastingly, when a destination is an apparatus (e.g., client PC 3000) other than the image forming apparatus, it is determined that a “specific condition” is satisfied, and data is transmitted to the apparatus after performing a virus check.

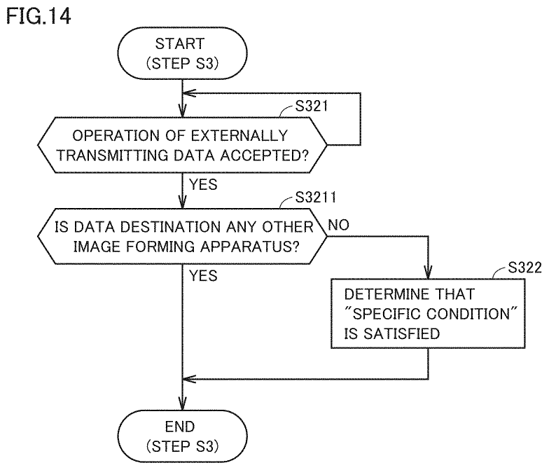

FIG. 14 is a flowchart showing the modification of step S3.

Referring to FIG. 14, at step S321, control unit 590 (controller 31) of image forming apparatus 1000 determines whether it has accepted an operation of externally transmitting data. When determining that it has accepted the operation (YES at step S321), at step S3211, control unit 590 determines whether a data destination is any other image forming apparatus (in this example, image forming apparatus 4000 shown in FIG. 1).

When determining that a data destination is any other image forming apparatus (YES at step S3211), control unit 590 ends the process. When determining that a data destination is not any other image forming apparatus (NO at step S3211), at step S322, control unit 590 determines that a “specific condition” is satisfied.

### (2) Second Modification (Process in FAX Transmission)

For example, for FAX data transmitted from image forming apparatus 1000 through a telephone line, a FAX receiver at the destination only prints the received data, leading to a low risk of virus infection at the destination. Even when image forming apparatus 1000 externally transmits data, thus, image forming apparatus 1000 does not determine that a “specific condition” is satisfied and performs FAX transmission without performing a virus check. Contrastingly, for a transmission process other than FAX transmission, image forming apparatus 1000 determines that a “specific condition” is satisfied and performs data transmission after performing a virus check.

In the execution of this modification, it suffices that the process of step S3211 in FIG. 14 is changed from “IS DATA DESTINATION ANY OTHER IMAGE FORMING APPARATUS?” to “FAX TRANSMISSION?”

### (3) Third Modification (Process Based on Presence or Absence of Virus Check Function of Any Other Apparatus)

For example, the following is conceivable. The image forming apparatus inquires of an apparatus (e.g., client PC 3000 in this example), which is a destination to which the image forming apparatus transmits data, whether antivirus software is installed in the destination apparatus through a network. Then, after the installation is confirmed, any virus contained in data transmitted from the image forming apparatus to the destination apparatus can be dealt with by the antivirus software of the destination apparatus.

An existing technique may be used to check the presence or absence of antivirus software in the destination apparatus. For example, when the OS of the destination apparatus is Windows (registered trademark), an installed software list can be acquired by a standard command of Windows. It is thus conceivable that whether antivirus software is installed can be determined by referring to a result of the acquisition.

In this modification, thus, when a destination apparatus includes antivirus software, image forming apparatus 1000 does not determine that a “specific condition” is satisfied and performs data transmission without performing a virus check. Contrastingly, when the destination apparatus includes no antivirus software, image forming apparatus 1000 determines that a “specific condition” is satisfied and performs a virus check on transmission data.

In the execution of this modification, it suffices that the step of “checking the presence or absence of a virus check function of a destination apparatus” is added between step S321 and step S3211 in FIG. 14, and that the process of step S3211 is changed from “IS DATA DESTINATION ANY OTHER IMAGE FORMING APPARATUS?” to “VIRUS CHECK FUNCTION PRESENT IN DESTINATION?”

The apparatus at the data destination in this modification is not limited to a PC and may be any other image forming apparatus.

### (4) Fourth Modification (Process Based on Creator of Data)

For example, it is conceivable that if the file creator is a person in the same company, his/her data may be regarded as credible data, and there may be no need for a virus check. As a method of determining whether the creator is a person in the company, for example, a user, who is registered as a user in image forming apparatus 1000. can be regarded as a person in the same company.

Contrastingly, it is conceivable that for a file which is acquired over the Internet or the like and whose creator is unspecified, this file may be regarded as containing a virus, and a virus check may be required. The information about the file creator can be checked from the header information of the file.

In this modification, thus, when the creator is a specific person, image forming apparatus 1000 does not determine that a “specific condition” is satisfied and transmits data without performing a virus check. Contrastingly, when the creator of the transmission data is unknown, image forming apparatus 1000 determines that a “specific condition” is satisfied and performs a virus check.

In the execution of this modification, it suffices that the process of step S3211 in FIG. 14 is changed from “IS DATA DESTINATION ANY OTHER IMAGE FORMING APPARATUS?” to “IS CREATOR OF TRANSMISSION DATA SPECIFIC PERSON (REGISTERED PERSON)?”

### (5) Fifth Modification (Process Based on Past Transmission History)

For example, for every data held by image forming apparatus 1000, a record regarding whether the data has a transmission track record is kept. Image forming apparatus 1000 refers to this record when transmitting data, and performs a data transmission without performing a virus check on data which has a transmission track record (i.e., which has been subjected to a virus check). This record may be written in, for example, a header of each piece of data for management. Alternatively, a file for recording may be prepared separately from each piece of data, and the record may be managed collectively in the file.

In this modification, when data having a transmission track record is transmitted again, image forming apparatus 1000 does not determine that a “specific condition” is satisfied and performs data transmission without performing a virus check. Contrastingly, in transmission of data having no transmission track record, image forming apparatus 1000 determines that a “specific condition” is satisfied and performs a virus check on the data to be transmitted.

In the execution of this modification, it suffices that the process of step S3211 in FIG. 14 is changed from “IS DATA DESTINATION ANY OTHER IMAGE FORMING APPARATUS?” to “DOES TRANSMISSION DATA HAVE TRANSMISSION TRACK RECORD?”

### c4. Fourth Specific Example (Process Example Based on Internal Data Movement)

Image forming apparatus 1000 divides save areas, in which data is stored, depending on intended use. Image forming apparatus 1000 has two areas: an area accessible from outside (hereinbelow, also referred to as a “shared storage area”) and an area inaccessible from outside (hereinbelow, also referred to as a “dedicated storage area”). In this case, when the data in the dedicated storage area is moved or copied to the shared storage area, it is conceivable that the data will be achieved externally after the movement or copying.

When data is stored in the shared storage area through movement or copying, image forming apparatus 1000 determines that a “specific condition” is satisfied and performs a virus check on the stored data.

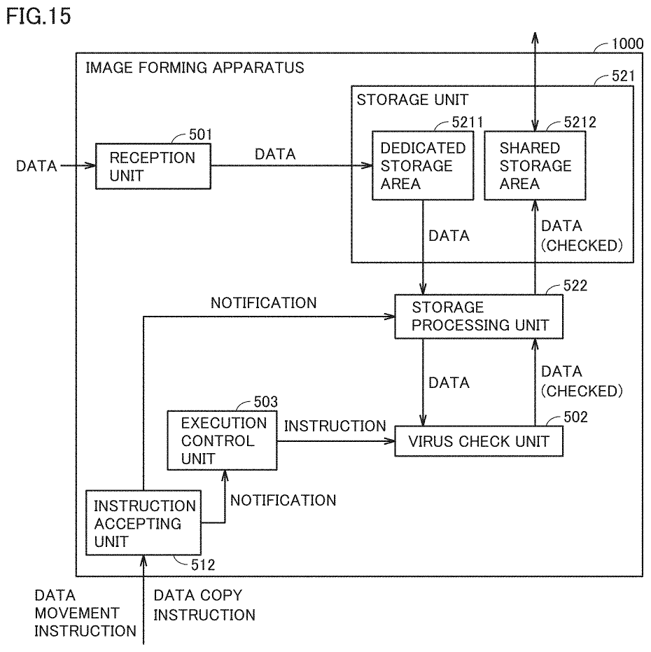

FIG. 15 is a functional block diagram for illustrating a fourth specific example of the functional configuration of image forming apparatus 1000.

Referring to FIG. 15, image forming apparatus 1000 includes reception unit 501, virus check unit 502, execution control unit 503, storage unit 521, instruction accepting unit 512, and storage processing unit 522. Execution control unit 503 and storage processing unit 522 are included in control unit 590. Storage unit 521 includes a dedicated storage area (first storage area) 5211 and a shared storage area (second storage area) 5212.

Data received from client PC 2000 by reception unit 501 is stored in storage unit 521. Specifically, the data is stored in dedicated storage area 5211 of storage unit 521.

Instruction accepting unit 512 accepts various instructions as described above. In this example, instruction accepting unit 512 accepts an instruction to store the data stored in dedicated storage area 5211 of storage unit 521 in shared storage area 5212 of storage unit 521 through movement or copying (hereinbelow, also referred to as “storage instruction”).

Upon receipt of a storage instruction, instruction accepting unit 512 sends predetermined notifications to execution control unit 503 and storage processing unit 522.

Upon receipt of the notification from instruction accepting unit 512, storage processing unit 522 reads data from dedicated storage area 5211. Execution control unit 503 instructs virus check unit 502 to perform a virus check on the data read from dedicated storage area 5211 by storage processing unit 522.

Virus check unit 502 transmits the data whose virus check is complete to storage processing unit 522. Storage processing unit 522 writes the data whose virus check is complete in shared storage area 5212 of storage unit 521.

In this manner, image forming apparatus 1000 includes at least the dedicated storage area that has limited access from outside and stores data received by reception unit 501, the shared storage area accessible from outside, and storage processing unit 522 that causes the shared storage area to store the data stored in the dedicated storage area.

Execution control unit 503 is triggered by the storing of data in shared storage area 5212 to cause virus check unit 502 to perform a virus check on the data stored in shared storage area 5212.

Such a configuration can less affect the productivity of image forming apparatus 1000 than a conventional virus check method (a method of starting a virus check upon receipt of data) while preventing damage due to secondary infection from image forming apparatus 1000 to any other apparatus.

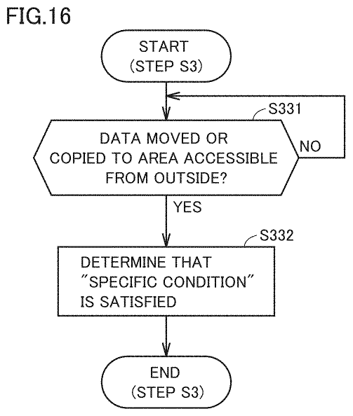

FIG. 16 is a flowchart showing a specific example of step S3.

Referring to FIG. 16, at step S331, control unit 590 (controller 31) of image forming apparatus 1000 determines whether data has been moved or copied to an area accessible from outside (i.e., shared storage area 5212).

When determining that data has been moved or copied (YES at step S331), at step S332, control unit 590 determines that a “specific condition” is satisfied. When determining that data has not been moved or copied (NO at step S331), control unit 590 returns the process to step S331.

### c5. Fifth Specific Example (Process Example Based on Editing Process)

Image forming apparatus 1000 is accessed from operation panel 34 of image forming apparatus 1000 or an external apparatus (e.g., client PC 3000), so that data held by image forming apparatus 1000 can be edited. For example, an editing operation is possible, such as adding a stamp of date or character to data, or combining a plurality of images into one image and storing a resultant image.

When a malicious person uses such an editing function, the following can occur. For example, a QR code (registered trademark) leading to a malicious website is put in an invisible place of image data, and a user who has printed this image data points a camera to a sheet of paper printed using his/her own smartphone, so that the smartphone may automatically recognize the QR code and access the malicious website at its own initiative.

Considering the above, when held data is edited, image forming apparatus 1000 determines that a “specific condition” is satisfied and performs a virus check on the edited data (i.e., data after editing).

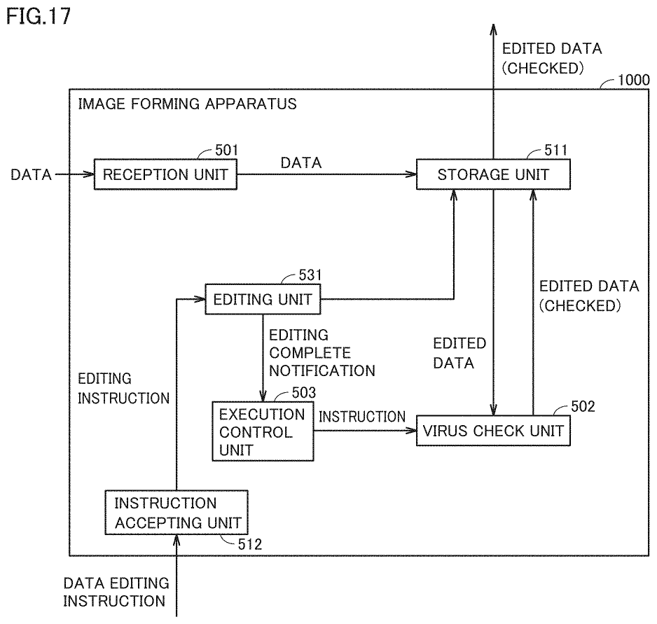

FIG. 17 is a functional block diagram for illustrating a fifth specific example of the functional configuration of image forming apparatus 1000.

Referring to FIG. 17, image forming apparatus 1000 includes reception unit 501, virus check unit 502, execution control unit 503, storage unit 511, an editing unit 531, and instruction accepting unit 512. Execution control unit 503 and editing unit 531 are included in control unit 590.

Data received from client PC 2000 by reception unit 501 is stored in storage unit 511.

Instruction accepting unit 512 accepts a data edit instruction from any other apparatus such as client PC 3000 through network NW. In this example, upon receipt of the edit instruction, instruction accepting unit 512 notifies editing unit 531 of the edit instruction.

Upon receipt of the notification from instruction accepting unit 512, editing unit 531 performs editing based on the edit instruction on the data stored in storage unit 511. Upon completion of the editing, editing unit 531 provides an edit complete notification to execution control unit 503.

Execution control unit 503 instructs virus check unit 502 to perform a virus check on the edited data. Virus check unit 502 stores the data whose virus check is complete in storage unit 511.

In this manner, image forming apparatus 1000 includes at least editing unit 531 that performs instructed editing on the data received by reception unit 501. Execution control unit 503 is triggered by the completion of the editing on the data by editing unit 531 to cause virus check unit 502 to start a virus check on the edited data.

Such a configuration can less affect the productivity of image forming apparatus 1000 than a conventional virus check method (a method of starting a virus check at receipt of data) while preventing damage due to secondary infection from image forming apparatus 1000 to any other apparatus.

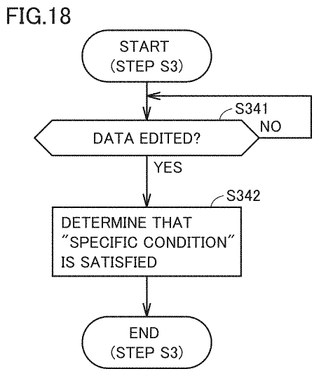

FIG. 18 is a flowchart showing a specific example of step S3.

Referring to FIG. 18, at step S341, control unit 590 (controller 31) of image forming apparatus 1000 determines whether data has been edited. When determining that data has been edited (YES at step S341), at step S342, control unit 590 determines that a “specific condition” is satisfied. When determining that data has not been edited (NO at step S341), control unit 590 returns the process to step S341.

### c6. Sixth Specific Example (Process Example Based on Compression Process)

Image forming apparatus 1000 has a compression (unction of reducing the size of held data. Examples of the case in which the compression function is used include the ease in which a reduction in the usage of HDD is aimed, as well as the case in which a transmission time is reduced by reducing a data size when data is externally transmitted.

Image forming apparatus 1000 then regards that. at a point of time when data is compressed, the data may be transmitted after the compression, and determines that a “specific condition” is satisfied and performs a virus check on the data (i.e., compressed data).

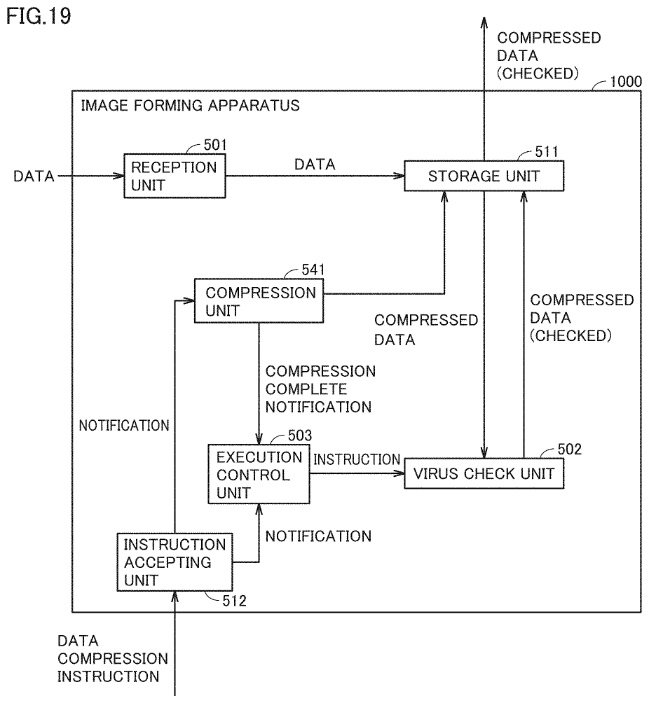

FIG. 19 is a functional block diagram for illustrating a sixth specific example of the functional configuration of image forming apparatus 1000.

Referring to FIG. 19, image forming apparatus 1000 includes reception unit 501, virus check unit 502, execution control unit 503, storage unit 511, instruction accepting unit 512, and a compression unit 541. Execution control unit 503 and compression unit 541 are included in control unit 590.

Data received from client PC 2000 by reception unit 501 is stored in storage unit 511.

Instruction accepting unit 512 accepts a data compression instruction through network NW or operation panel 34. Upon receipt of the compression instruction, instruction accepting unit 512 notifies compression unit 541 of the compression instruction.

Upon receipt of the notification from instruction accepting unit 512, compression unit 541 compresses the data stored in storage unit 511. Upon completion of the compression, compression unit 541 provides a compression complete notification to execution control unit 503.

Execution control unit 503 instructs virus check unit 502 to perform a virus check on the compressed data. Virus check unit 502 stores the data whose virus check is complete in storage unit 511.

In this manner, image forming apparatus 1000 includes at least compression unit 541 that compresses data received by reception unit 501. Execution control unit 503 is triggered by an end of the compression of data by compression unit 541 to cause virus check unit 502 to perform a virus check on the compressed data.

Such a configuration can less affect the productivity of image forming apparatus 1000 than a convention virus check method (a method of starting a virus check upon receipt of data) while preventing damage due to secondary infection from image forming apparatus 1000 to any other apparatus.

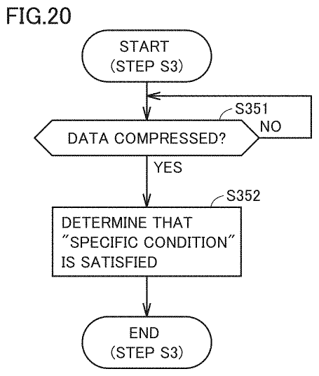

FIG. 20 is a flowchart showing a specific example of step S3.

Referring to FIG. 20, at step S351, control unit 590 (controller 31) of image forming apparatus 1000 determines whether data has been compressed. When determining that data has been compressed (YES at step S351), at step S352, control unit 590 determines that a “specific condition” is satisfied. When determining that data has not been compressed (NO at step S351), control unit 590 returns the process to step S351.

### c7. Seventh Specific Example (Process Example Based on Automatic Delete Function)

Image forming apparatus 1000 has a function of automatically deleting data after transmitting the data (hereinafter, referred to as “automatic delete function”). That is to say, image forming apparatus 1000 has a function of regarding data as being no longer in use after transmitting the data and automatically deleting the data.

Image forming apparatus 1000 can set the automatic delete function to any one of valid and invalid per data. When the user manually (i.e., intentionally) changes the setting of the data automatic delete function (specifically, when the user switches the valid setting to the invalid setting, or when the user switches the invalid setting to the valid setting), it can be conceivable that the user will change the setting with the intention to transmit the data in the future.

Thus, when a setting value of the automatic delete function is switched, image forming apparatus 1000 determines that a “specific condition” is satisfied and performs a virus check on the data.

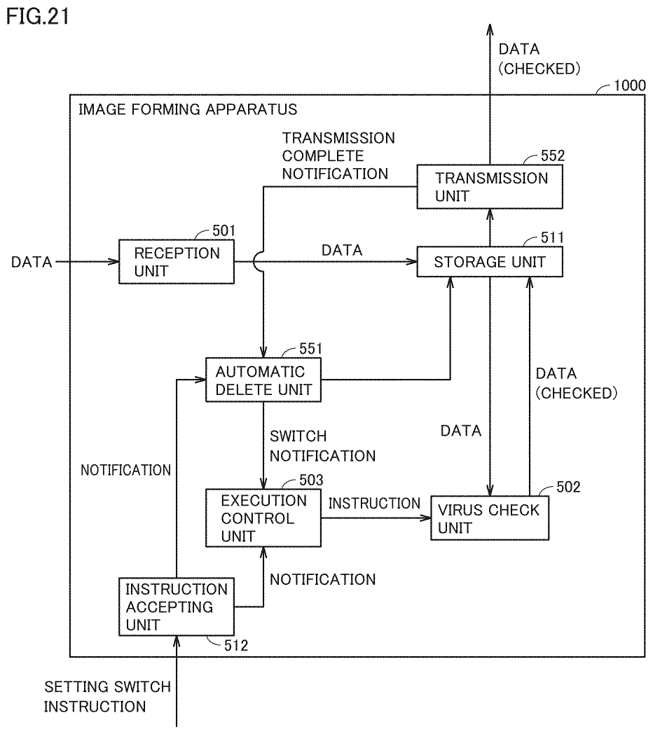

FIG. 21 is a functional block diagram for illustrating a seventh specific example of the functional configuration of image forming apparatus 1000.

Referring to FIG. 21, image forming apparatus 1000 includes reception unit 501, virus check unit 502, execution control unit 503, storage unit 511, instruction accepting unit 512, an automatic delete unit 551, and a transmission unit 552. Execution control unit 503 and automatic delete unit 551 are included in control unit 590.

Data received from client PC 2000 by reception unit 501 is stored in storage unit 511.

Instruction accepting unit 512 accepts a switch instruction to switch the setting of the automatic delete function through network NW or operation panel 34. Upon receipt of the switch instruction, instruction accepting unit 512 notifies automatic delete unit 551 of the switch instruction. As described above, the setting of the automatic delete function can be performed per data.

Upon receipt of the notification from instruction accepting unit 512, automatic delete unit 551 changes the setting to a value based on the switch instruction. For example, automatic delete unit 551 switches the valid setting to the invalid setting or the invalid setting to the valid setting. Upon completion of the change, automatic delete unit 551 provides the switch notification to execution control unit 503.

Upon receipt of the switch notification, execution control unit 503 instructs virus check unit 502 to perform a virus check on the data stored in storage unit 511 (more specifically, data whose setting of the automatic delete function has been changed). Virus check unit 502 stores the data whose virus check is complete in storage unit 511.

When transmission unit 552 transmits data based on the instruction from control unit 590, and when setting is made such that the data is to be deleted after the transmission, automatic delete unit 551 deletes the data from storage unit 511.

Specifically, transmission unit 552 transmits a transmission complete notification, indicating the completion of the data transmission, to automatic delete unit 551. Automatic delete unit 551 accepts a data transmission complete notification and, when the setting of the automatic delete function of the data is the valid setting, deletes the data from storage unit 511.

In this manner, image forming apparatus 1000 includes at least storage unit 511 that stores data received by reception unit 501, automatic delete unit 551 that automatically deletes the data from storage unit 511 based on the setting being valid and the stored data having been externally transmitted, and instruction accepting unit 512 that accepts the switch instruction to switch the setting between valid and invalid.

Execution control unit 503 is triggered by the acceptance of the switch instruction by the instruction accepting unit 512 to cause virus check unit 502 to start a virus check on the data stored in storage unit 511.

Such a configuration can less affect the productivity of image forming apparatus 1000 than a conventional virus check method (a method of starting a virus check upon receipt of data) while preventing damage due to secondary infection from image forming apparatus 1000 to any other apparatus.

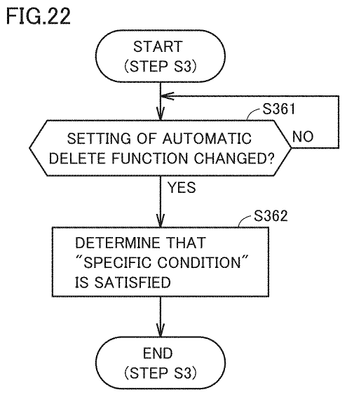

FIG. 22 is a flowchart showing a specific example of step S3.

Referring to FIG. 22, at step S361, control unit 590 (controller 31) of image forming apparatus 1000 determines whether the setting of the automatic delete function has been changed. When determining that the setting has been changed (YES at step S361), at step S362, control unit 590 determines that a “specific condition” is satisfied. When determining that the setting has not been changed (NO at step S361), control unit 590 returns the process to step S361.

Although the “specific condition” has been described using a plurality of examples, the specific condition is not limited thereto. For example, the specific condition may be “a state in which no job is stored in image forming apparatus 1000.”

### Summary

According to an aspect of the present disclosure, an image forming apparatus includes virus check means for performing a virus check, receiving means for receiving data from an external apparatus, and execution control means for causing the virus check means to perform the virus check on the data when a specific condition is satisfied after the receipt of the data.

Preferably, the execution control means determines whether a specific condition is satisfied after the receipt of the data. The execution control means causes the virus check means to perform the virus check on the data based on the determination that the specific condition is satisfied.

Preferably, the image forming apparatus further includes a processor that controls an operation of the image forming apparatus. The specific condition is that a load of the processor is less than a threshold.

Preferably, the execution control means causes the virus check means to interrupt the virus check when the load of the processor reaches the threshold or more during the virus check. The execution control means causes the virus check means to restart the virus check when the load of the processor falls below the threshold after the interruption of the virus check.

Preferably, the image forming apparatus further includes a processor that controls an operation of the image forming apparatus. The execution control means determines whether to cause the virus check means to perform the virus check on the data in accordance with the load of the processor.

Preferably, the execution control means determines that the specific condition is not satisfied during image formation, scanning, or image stabilization by the image forming apparatus.

Preferably, the image forming apparatus further includes transmission means for transmitting the data to a designated destination through a network, and setting means for setting a transmission time of the data. The specific condition is that the setting has been made after the receipt of the data. The execution control means is triggered by the setting made after the receipt of the data to cause the virus check means to start the virus check on the data.

Preferably, the image forming apparatus further includes a first storage area that stores the data received by the receiving means, instruction accepting means for accepting an instruction set in advance, storage processing means for causing, in response to the acceptance of the instruction by the accepting means, and a second storage area based on the instruction to store the data stored in the first storage area. The specific condition is that the instruction accepting means has accepted the instruction. The execution control means is triggered by the acceptance of the instruction by the instruction accepting means to cause the virus check means to perform the virus check on the data before storing the data in the second storage area.

Preferably, the storage processing means transmits the data to the second storage area through a network. The execution control means causes the virus check means to perform the virus check on the data before the data is transmitted by the storage processing means.

Preferably, the second storage area is a storage area of a storage medium to be connected to the image forming apparatus without a network.

Preferably, the execution control means causes the virus checker to interrupt the virus check when a new job occurs during the virus check. The image forming apparatus further includes a display unit and display control means for causing, in response to the interruption of the virus check, the display unit to display completion of the transmission of the data. The execution control means causes, when the job is complete, the virus check means to restart the virus check that has been interrupted.

Preferably, the image forming apparatus further includes a first storage area that has limited access from outside and stores data received by the receiving means, a second storage are accessible from outside, and storage processing means for causing the second storage area to store the data stored in the first storage area. The specific condition is that the data has been stored in the second storage area.

Preferably, the image forming apparatus further includes edit means for performing an instructed edit on the data received by the receiving means. The specific condition is that the instructed edit has been performed by the editing means. The execution control means is triggered by completion of the instructed edit on the data by the edit means to cause the virus check means to start the virus check on the data after the edit.

Preferably, the image forming apparatus further includes compression means for compressing the data received by the receiver. The specific condition is that the compression has been performed on the data by the compression means. The execution control means is triggered by completion of the compression on the data by the compression means to cause the virus check means to start the virus check on the data after the compression.

Preferably, the image forming apparatus further includes storage means for storing the data received by the receiving means, deleting means for automatically deleting the data from the storage means based on the setting being valid and the transmission of the stored data having been transmitted to outside, and instruction accepting means for accepting a switch instruction to switch the setting between valid and invalid. The specific condition is that the switch instruction has been accepted.

Preferably, the specific condition is a state in which no job is stored in the image forming apparatus.

According to another aspect of the present disclosure, a virus check method includes receiving data form an external apparatus, and performing a virus check on the data on a condition that a specific condition is satisfied after the receipt of the data.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a virus checker that performs a virus check;
a receiver that receives data from an external apparatus; and
a controller that causes the virus checker to perform the virus check on the data when a specific condition is satisfied after the receipt of the data.

2. The image forming apparatus according to claim 1, wherein the controller
determines whether the specific condition is satisfied after the receipt of the data, and
causes the virus checker to perform the virus check on the data based on the determination that the specific condition is satisfied.

3. The image forming apparatus according to claim 1, wherein
the controller includes a processor that controls an operation of the image forming apparatus, and
the specific condition is that a load of the processor is less than a threshold.

4. The image forming apparatus according to claim 3, wherein the controller
causes the virus checker to interrupt the virus check when the load of the processor reaches the threshold or more during the virus check, and
causes the virus checker to restart the virus check when the load of the processor falls below the threshold after the interruption of the virus check.

5. The image forming apparatus according to claim 1, further comprising a processor that controls an operation of the image forming apparatus,
wherein the controller determines whether to cause the virus checker to perform the virus check on the data in accordance with a load of the processor.

6. The image forming apparatus according to claim 1, wherein the controller determines that the specific condition is not satisfied during image formation, scanning, or image stabilization by the image forming apparatus.

7. The image forming apparatus according to claim 1, further comprising a transmitter that transmits the data to a designated destination through a network, wherein
the controller sets a transmission time of the data,
the specific condition is that the setting has been made after the receipt of the data, and
the controller is triggered by the setting made after the receipt of the data to cause the virus checker to start the virus check on the data.

8. The image forming apparatus according to claim 1, further comprising a first storage area that stores the data received by the receiver,
wherein the controller
accepts an instruction set in advance,
in response to the acceptance of the instruction, causes a second storage area based on the instruction to store the data stored in the first storage area,
the specific condition is that the controller has accepted the instruction, and
the controller is triggered by the acceptance of the instruction to cause the virus checker to perform the virus check on the data before storing the data in the second storage area.

9. The image forming apparatus according to claim 8, wherein the controller
transmits the data to the second storage area through a network, and
causes the virus checker to perform the virus check on the data before the data is transmitted.

10. The image forming apparatus according to claim 8, wherein the second storage area is a storage area of a storage medium to be connected to the image forming apparatus without a network.

11. The image forming apparatus according to claim 9, wherein
the controller causes the virus checker to interrupt the virus check when a new job occurs during the virus check,
the image forming apparatus further comprises a display,
the image forming apparatus causes, in response to the interruption of the virus check, the display to display completion of the transmission of the data, and
the controller causes, when the job is complete, the virus checker to restart the virus check that has been interrupted.

12. The image forming apparatus according to claim 1, further comprising:
a first storage area that has limited access from outside and stores the data received by the receiver; and
a second storage area accessible from outside, wherein
the controller causes the second storage area to store the data stored in the first storage area, and
the specific condition is that the data has been stored in the second storage area.

13. The image forming apparatus according to claim 1, wherein
the image forming apparatus performs an instructed edit on the data received by the receiver,
the specific condition is that the instructed edit on the data has been performed, and
the controller is triggered by an end of the instructed edit on the data to cause the virus checker to start the virus check on the data after the edit.

14. The image forming apparatus according to claim 1, wherein
the image forming apparatus compresses the data received by the receiver,
the specific condition is that the data has been compressed, and
the controller is triggered by an end of the compression on the data to cause the virus checker to start the virus check on the data after the compression.

15. The image forming apparatus according to claim 1, further comprising a memory that stores the data received by the receiver, wherein
the image forming apparatus automatically deletes the data from the memory based on a setting being valid and the stored data having been externally transmitted,
the image forming apparatus accepts a switch instruction to switch the setting between valid and invalid, and
the specific condition is that the switch instruction has been accepted.

16. The image forming apparatus according to claim 1, wherein the specific condition is a state in which no job is stored in the image forming apparatus.

17. A virus check method comprising:
receiving data from an external apparatus; and
performing a virus check on the data on a condition that a specific condition is satisfied after the receipt of the data.

18. The virus check method according to claim 17, further comprising determining whether the specific condition is satisfied after the receipt of the data,
wherein in the performing of the virus check, the virus check is performed on the data based on the determination that the specific condition is satisfied.

19. The virus check method according to claim 17, wherein
the virus check method is performed by an image forming apparatus, and
the specific condition is that a load of a processor of the image forming apparatus is less than a threshold.

20. The virus check method according to claim 17, wherein
the virus check method is performed by an image forming apparatus, and
the virus check method further comprises determining whether to perform the virus check on the data in accordance with a load of a processor of the image forming apparatus.
